(19) United States
(12) Patent Application Publication
(10) Pub. No.: US 2025/0203367 A1
(43) Pub. Date: Jun. 19, 2025

(54) ENABLING CELLULAR BASED ZERO TRUST NETWORK ACCESS

(71) Applicant: Telefonaktiebolaget LM Ericsson (publ), Stockholm (SE)

(72) Inventors: Wassim Michel HADDAD, San Jose, CA (US); Giuseppe BURGARELLA, Dublin, CA (US); Massimiliano MAGGIARI, Pleasanton, CA (US)

(21) Appl. No.: 18/866,988

(22) PCT Filed: Jan. 28, 2023
(86) PCT No.: PCT/IB2023/050748

§ 371 Date: Nov. 18, 2024

Related U.S. Application Data
(60) Provisional application No. 63/344,538, filed on May 21, 2022.

(51) Int. Cl. H04W 12/08; H04W 12/0433

(52) U.S. Cl. CPC H04W 12/08; H04W 12/0433

(57) ABSTRACT

A method performed by a user equipment to establish a secured connection with an application entity in an enterprise network. The method comprises sending an establishment request to a secure access secure edge (SASE) entity: receiving an establishment response from the application entity if the SASE entity determines to allow the establishment request and authorizes Generic Bootstrapping Architecture/Authenticated Key Management for Application (GBA/AKMA) platform to share a session key with the application entity; and establishing a connection with the application entity based on the session key.

### CROSS REFERENCE TO RELATED APPLICATION

This application claims priority under 35 U.S.C. § 119 (e) to U.S. Provisional Patent Application No. 63/344,538 filed on May 21, 2022, titled “Enabling 4G 5G Based Zero Trust Network Access.” The contents of the application are hereby incorporated by reference in their entirety for all purposes.

### FIELD

The present disclosure relates generally to communication systems and, more specifically, to a method and apparatus for establishing a secured connection between a user equipment and an application entity in an enterprise network.

### BACKGROUND

Remote employees are relying on virtual private network (VPN) technologies to access corporate information technology (IT) services. For this purpose, VPN tunnels are set up between employees' devices, such as laptop, tablet, etc., and remote dedicated VPN gateways (GWs).

VPN GWs can be deployed behind corporate firewalls. In such a setup, it is difficult for an IT department to gain desired visibility into remote user devices' activities. For example, they cannot have the same level of visibility as when the users are working at the offices.

In fact, in order to improve visibility into user devices' activities, the IT department often collects logs from different corporate applications, which may not be an easy task. Furthermore, it is desirable for the IT department to gain dynamic granular control over the user devices and what they can access, as well as the location and time of access.

### SUMMARY

Various computer-implemented systems, methods, and articles of manufacture for establishing a secured connection with an enterprise application entity in an enterprise network are described herein.

In some embodiments, a method performed by a user equipment (UE) for establishing a secured connection with an application entity in an enterprise network is disclosed. The method comprises sending an establishment request to a secure access secure edge (SASE) entity: receiving an establishment response from the application entity if the SASE entity determines to allow the establishment request and authorizes Generic Bootstrapping Architecture/Authenticated Key Management for Application (GBA/AKMA) platform to share a session key with the application entity; and establishing a connection with the application entity based on the session key. In the below description, user equipment is also referred to as an end user device.

In some embodiments, a method performed by a Secure Access Secure Edge (SASE) entity for establishing a secured connection between a user equipment and an application entity in an enterprise network is disclosed. The method comprises receiving an establishment request from the user equipment: determining whether to allow the establishment request: sending an initiate message to a Generic Bootstrapping Architecture/Authenticated Key Management for Application (GBA/AKMA) platform if the SASE entity determines to allow the establishment request: receiving an acknowledgement (ACK) response from the GBA/AKMA platform; and sending a session establishment request message to the application entity. The initiate message comprises an authorization to share a session key with the application entity.

In some embodiments, a method performed by a computer-implemented controller for establishing a secured connection between a user equipment and an application entity in an enterprise network is disclosed. The method comprises receiving an establishment request from the user equipment: determining whether to allow the establishment request: sending an initiate message to a GBA/AKMA platform if the computer-implemented controller determines to allow the establishment request: receiving an acknowledgement (ACK) response from the GBA/AKMA platform; and sending a session establishment request message to the application entity. The initiate message comprises an authorization to share a session key with the application entity.

Embodiments of a UE and a computer-implemented controller are also provided according to the above method embodiments.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 illustrates an example communication system in accordance with some embodiments.

FIG. 2 illustrates an example user equipment in accordance with some embodiments.

FIG. 3 illustrates an example network node in accordance with some embodiments.

FIG. 4 illustrates a block diagram of a host in accordance with some embodiments.

FIG. 5 illustrates a block diagram illustrating a virtualization environment in accordance with some embodiments.

FIG. 6 illustrates a communication diagram of a host communicating via a network node with a user equipment over a partially wireless connection in accordance with some embodiments.

FIG. 7 illustrates a communication diagram of an end user device communicating with enterprise application entities via a secure access secure edge (SASE) entity using VPN between the end user device and the SASE entity.

FIG. 8 illustrates an example communication diagram of an end user device communicating with enterprise application entities via an enhanced user plane function (E-UPF) having an SASE entity using VPNs between the end user device and the enterprise application entities.

FIG. 9 shows an example signal sequence diagram illustrating the process of establishing a secured connection between an end-user device and an enterprise application entity in an enterprise network according to an embodiment of the present disclosure.

FIG. 10 shows an example flowchart illustrating an example method performed by a user equipment for establishing a secured connection with an enterprise application entity in an enterprise network in accordance with some embodiments of the present disclosure.

FIG. 11 shows an example flowchart illustrating an example method performed by an SASE entity for establishing a secured connection between a user equipment and an enterprise application entity in an enterprise network in accordance with some embodiments of the present disclosure.

### DETAILED DESCRIPTION

To provide a more thorough understanding of the present disclosure, the following description sets forth numerous specific details, such as specific configurations, parameters, examples, and the like. It should be recognized, however, that such description is not intended as a limitation on the scope of the present disclosure but is intended to provide a better description of the example embodiments.

Throughout the specification and claims, the following terms take the meanings explicitly associated herein, unless the context clearly dictates otherwise:

The phrase “In some embodiments” as used herein does not necessarily refer to the same embodiment, though it may. Thus, as described below, various embodiments of the present disclosure may be readily combined, without departing from the scope or spirit of the present disclosure.

As used herein, the term “or” is an inclusive “or” operator and is equivalent to the term “and/or,” unless the context clearly dictates otherwise.

The term “based on” is not exclusive and allows for being based on additional factors not described unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the terms “coupled to” and “coupled with” are also used to mean “communicatively coupled with”, possibly via one or more intermediary devices.

In addition, throughout the specification, the meaning of “a”, “an”, and “the” includes plural references, and the meaning of “in” includes “in” and “on”.

Although some of the various embodiments presented herein constitute a single combination of inventive elements, it should be appreciated that the inventive subject matter is considered to include all possible combinations of the disclosed elements. As such, if one embodiment comprises elements A, B, and C, and another embodiment comprises elements B and D, then the inventive subject matter is also considered to include other remaining combinations of A, B, C, or D, even if not explicitly discussed herein. Further, the transitional term “comprising” means to have as parts or members, or to be those parts or members. As used herein, the transitional term “comprising” is inclusive or open-ended and does not exclude additional, unrecited elements or method steps.

The present disclosure generally relates to an apparatus and method for establishing a secured connection with an application entity in an enterprise network. While the example embodiments described below are primarily described with respect to 4G and/or 5G communication networks, the disclosure is also applicable to existing technologies such as GSM, 3G, and other future technologies, such as 6G networks and beyond.

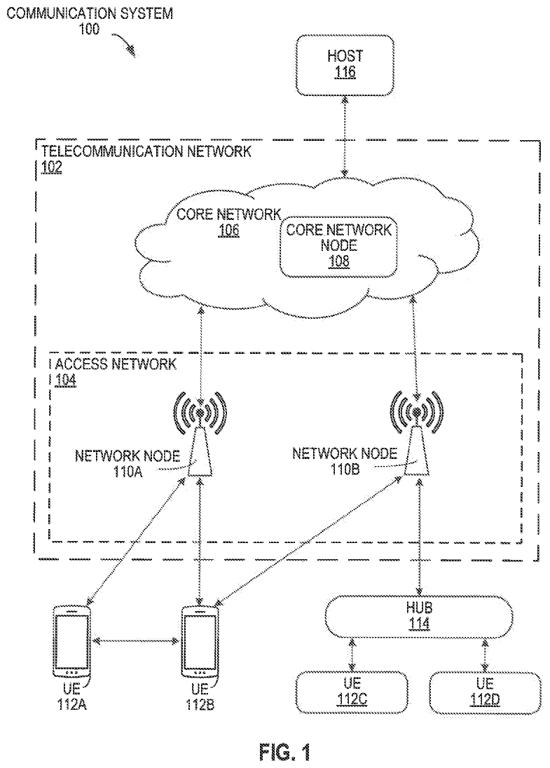

FIG. 1 shows an example of a communication system 100 in accordance with some embodiments.

In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3rd Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 1 enables connectivity between the UEs, network nodes, and hosts. In that sense, the communication system may be configured to operate according to predefined rules or procedures, such as specific standards that include, but are not limited to: Global System for Mobile Communications (GSM): Universal Mobile Telecommunications System (UMTS): Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

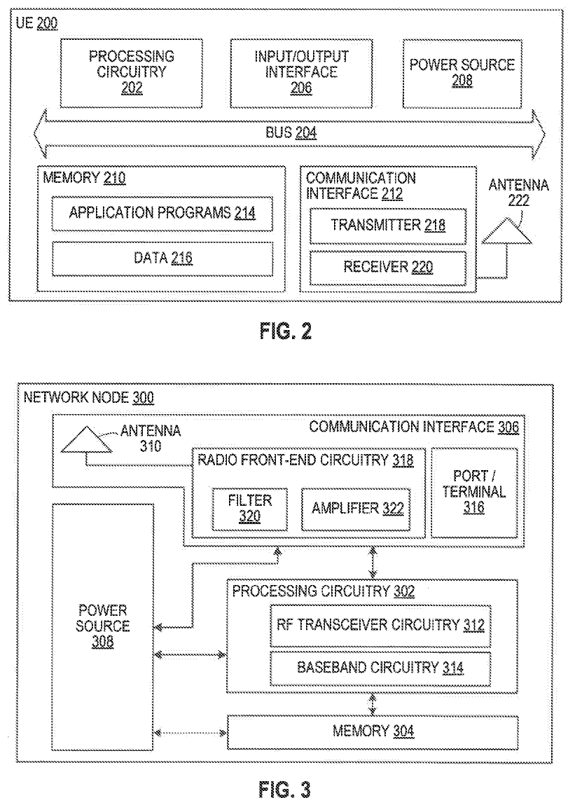

FIG. 2 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (cMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 2. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.): programmable logic together with appropriate firmware: one or more stored computer programs, general-purpose processors, such as a microprocessor or digital signal processor (DSP), together with appropriate software: or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (cUICC), integrated UICC (iUICC) or a removable UICC commonly known as “SIM card.” The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 2.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 3 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (cNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 3 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

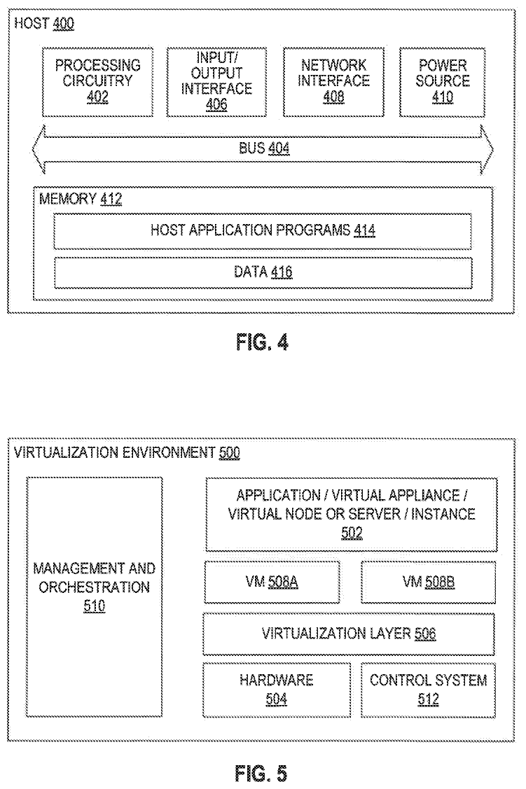

FIG. 4 is a block diagram of a host 400, which may be an embodiment of the host 116 of FIG. 1, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 2 and 3, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 5 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g., such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

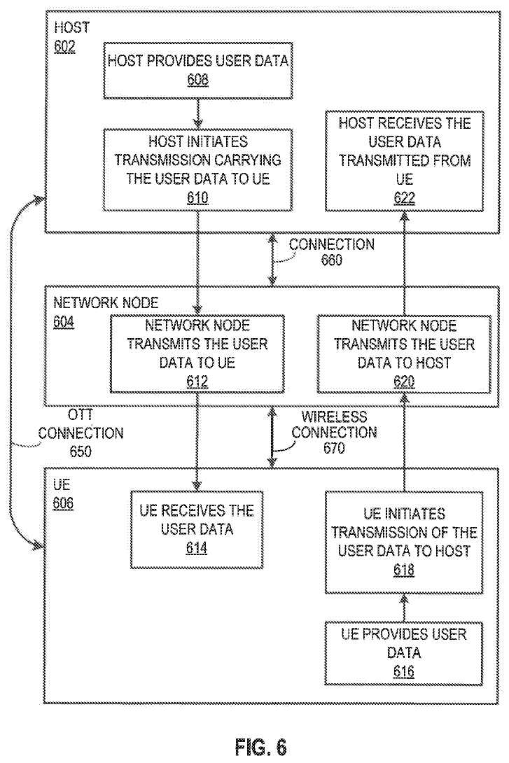

FIG. 6 shows a communication diagram of a host 602 communicating via a network node 604 with a UE 606 over a partially wireless connection in accordance with some embodiments. Example implementations, in accordance with various embodiments, of the UE (such as a UE 112a of FIG. 1 and/or UE 200 of FIG. 2), network node (such as network node 110a of FIG. 1 and/or network node 300 of FIG. 3), and host (such as host 116 of FIG. 1 and/or host 400 of FIG. 4) discussed in the preceding paragraphs will now be described with reference to FIG. 6.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 1) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve the energy consumption of UE 606 and thereby provide benefits such as increased battery life.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes: the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.: the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionalities may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

As described above, it is difficult for an IT department to gain desired visibility into remote user devices' activities. In order to improve visibility into user devices activities, the IT department often collects logs from different corporate applications, which may not be an easy task. Furthermore, it is desirable for the IT department to gain dynamic granular control over the user devices and what they can access, as well as the location and time of access. To solve or mitigate these problems, an SASE can be used to combine multiple functionalities into one entity.

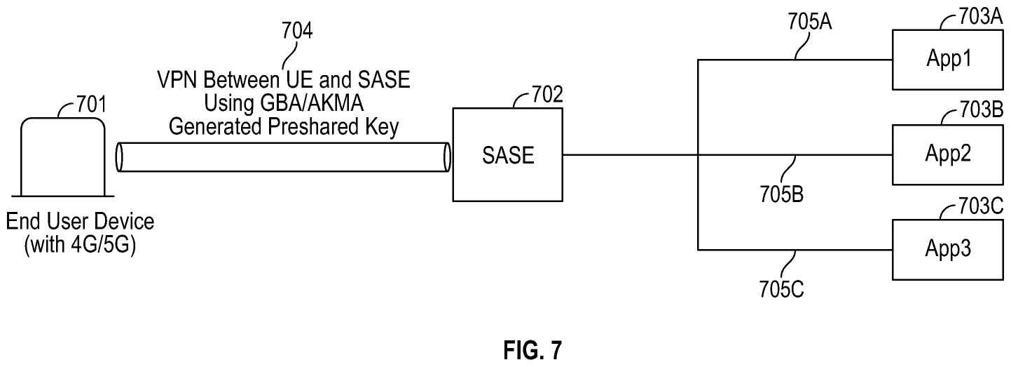

For example, the SASE would incorporate virtual private network (VPN) gateways (GWs), firewall, and software-defined wide area network (SD-WAN) capabilities. In such a scenario, any encrypted tunnel originating from an end user device (e.g., laptop, tablet, etc.) will be terminated at the SASE level regardless of the user's location. Then another encrypted tunnel is established between the SASE and the targeted application. The embodiment shown in FIG. 7 illustrates such a scenario. This type of technology may not leverage, for example, 4G/5G embedded securities, which can eliminate the need to break VPN tunnels at the SASE level where data can be decrypted and re-encrypted again.

FIG. 7 illustrates a communication diagram of an end user device 701 communicating via a secure access secure edge (SASE) entity 702 with enterprise application entities 703A-C using VPN 704 between the end user device 701 and the SASE entity 702. As shown in FIG. 7, the VPN 704 may be established between the end user device (e.g., laptop, tablet, etc.) 701 and the SASE entity 702 using a pre-shared key generated by Generic Bootstrapping Architecture/Authentication and Key Management for Applications (GBA/AKMA). Then other encrypted tunnels 705A-C may be established between the SASE entity 702 and the targeted applications 703A-C, respectively.

In the embodiments of the present disclosure, end user devices (also referred to as UE(s)) 701 may establish a VPN tunnel 704 with the SASE entity 702. A pre-shared key may be used to establish the VPN tunnel 704. Such a pre-shared key may be computed via a GBA and/or

AKMA platform (not shown in FIG. 7). In one embodiment, the end user device 701 communicates first with the GBA/AKMA platform in order to compute a session key; and the GBA/AKMA platform may share this key with the SASE entity 702. The goal behind deriving such a session key via the GBA/AKMA platform is to give the SASE entity 702 confidence about the end user device 701's identity. A pre-shared key computed via the GBA/AKMA platform is used to secure any communications between the end user device 701 and applications 703A-C authorized by the SASE entity 702.

In some embodiments, the end user device 701 may have 4G/5G eSIM (embedded SIM) profile installed. However, it is not mandatory for the end user device 701 to be connected to a 4G/5G network according to some embodiments of the present disclosure. But 5G connectivity may be needed if the GBA technology becomes obsolete. The GBA technology is currently available for 4G and may be extended to support 5G. The GBA platform enables user authentication, and it requires the end user device 701 to have a valid identity stored on the GBA platform. In some embodiments, the end user device 701's home network may play the role of an identity provider to provide the required valid identity to the GBA platform.

A GBA platform may not require a cellular connection, it can also work over a Wi-Fi connection. In some embodiments, the GBA platform and the end user device 701 mutually authenticate and agree on session keys that are afterwards applied between the end user device 701 and the GBA platform. Derived key material can be assigned to a GBA user. After the VPN 704 is established between the end user device 701 and the SASE entity 702 using a pre-shared key generated by the GBA platform, encrypted tunnels 705A-C may be established between the SASE 702 and the targeted applications 703A-C. The end user device 701 and applications 703A-C can securely communicate using session keys generated during the mutual authentication between the end user device 701 and the GBA platform.

Authenticated Key Management for Applications (AKMA) is GBA successor in 5G technologies. The AKMA service aims at establishing authenticated communication between an end user device like the end user device 701 and application functions, such as applications 703A-C. Like GBA, AKMA leverages an operator authentication infrastructure in order to secure the communication between the end user device 701 and applications 703A-C. Thus, the above descriptions with respect to the GBA platform can also be applied to an AKMA platform. In this disclosure, the GBA platform and the AKMA platform are sometimes used interchangeably, and sometimes referred to as the GBA/AKMA platform.

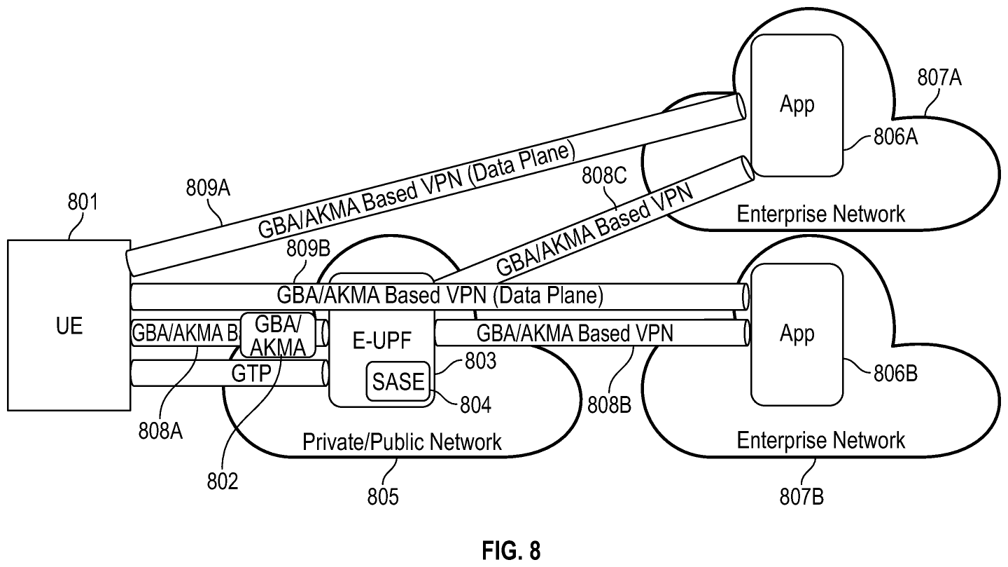

As described above, the type of configuration shown in FIG. 7 may not leverage, for example, 4G/5G embedded securities, and thus need to break the VPN tunnels at the SASE level where data are decrypted and re-encrypted again. FIG. 8 illustrates an example communication diagram of a user equipment (UE) 801 communicating via enhanced user plane function (E-UPF) 803 with enterprise application entities 806A-B using GBA/AKMA based VPNs between the end user device 801 and the enterprise application entities 806A-B. The enhanced user plane function (E-UPF) 803 may include a secure access secure edge (SASE) entity 804. The enterprise application entities 806A and 806B may be operating in enterprise networks 807A and 807B respectively. The enterprise application entities 806A and 806B may be able to communicate with a GBA/AKMA platform (e.g., platform 802) and be compliant with GBA/AKMA 3GPP specifications. In most cases, such GBA/AKMA platforms may reside in a telecommunication infrastructure. In some embodiments, the SASE entity 804 can securely communicate with GBA/AKMA platform 802. For further details on the generic bootstrapping architecture, reference can be made to the documents: European Telecommunications Standards Institute (ETSI) technical specification (TS) 133 220, ETSI TS 133 535, and ETSI TS 133 501, which are hereby incorporated in their entireties.

As shown in FIG. 8, the enhanced user plane function (E-UPF) 803 may combine the user plane function with functionalities of the SASE entity 804. In some embodiments, a user plane function (UPF) may support minimalistic functionalities regarding security (e.g., deep packet inspection), but it may not have sophisticated firewall or virtual private network (VPN) gateway (GW) functionalities. By combining functionalities of the SASE entity 804 with the UPF, these extra security functionalities may become part of an “enhanced UPF (E-UPF) 803” as shown in FIG. 8. Further, a GBA/AKMA platform 802 may be integrated with the SASE functionalities. In some embodiments, a computer-implemented controller may be used to implement the SASE entity 804. The controller may combine at least some functionalities of the SASE entity 804 with the functionalities of the UPF. The SASE entity 804 may use key exchange with UE 801 and/or the enterprise application entities 806A and 806B to establish secure communications. In some embodiments of the present disclosure, GBA/AKMA platform 802 may be used to compute and distribute the shared keys.

Specifically, referring to FIG. 8, user equipment (UE) 801 may communicate with the E-UPF 803 comprising the SASE entity 804 via general packet radio service (GPRS) tunneling protocol (GTP). The E-UPF 803 comprising the SASE entity 804 may be a part of a private or public network 805. The UE 801 may initiate communication with GBA/AKMA platform 802 and then the GBA/AKMK platform 802 may compute a session key based on the communication with the UE 801. Then the GBA/AKMK platform 802 may share the session key with the E-UPF 803 comprising the SASE entity 804, so that the SASE entity 804 has the confidence about the UE 801's device identity. For example, in some embodiments, the pre-shared key computed via GBA/AKMA platform 802 may be used to secure any communication between the UE 801 and an application authorized by the SASE entity 804. Then a GBA/AKMK based VPN 808A between the UE 801 and the SASE entity 804, a GBA/AKMK based VPN 808B between the SASE entity 804 and the enterprise application entity 806B, and a GBA/AKMK based VPN 808C between the SASE entity 804 and the enterprise application entity 806A may be established using a pre-shared key generated by the GBA/AKMK platform 802.

After GBA/AKMA based VPNs are established between the UE 801 and E-UPF 803 as well as between the E-UPF 803 and the enterprise application entities 806A and 806B, the UE 801 may send an establishment request, e.g., “app session establishment request” message, to SASE entity 804 according to an embodiment of the present disclosure. In some embodiments, the establishment request may include a request or attempt to connect with the enterprise application entity 806A or 806B. The SASE entity 804 may determine if the UE 801's request to connect to enterprise application entity 806A or 806B may be allowed. If the SASE entity 804 determines to allow the establishment request, the SASE entity 804 may authorize GBA/AKMA platform 802 to share the session key with the enterprise application entity 806A or 806B. In some embodiments, if the SASE entity 804 determines that the UE 801's requests may not be allowed, an error message may be sent to the UE 801. Connections between the UE 801 and the enterprise application entity 806A or 806B may thus be terminated.

In some embodiments, if the SASE entity 804 determines that the UE 801's request can be granted, the SASE entity 804 proceeds to communicate with the GBA/AKMA platform 802. For example, during one such communication, the SASE entity 804 may send an “App_Bootstrap_Initiate” (“AB_Init”) message to the GBA/AKMA platform 802 to authorize sharing the session key with the enterprise application entity 806A or 806B.

Upon receiving an AB_Init message from the SASE entity 804, the GBA/AKMA platform 802 may send an acknowledge (ACK) response to the SASE entity 804. After receiving the acknowledge response from the GBA/AKMA platform 802, the SASE entity 804 may forward the “app session establishment request” message to the enterprise application entity 806A or 806B. Upon receiving an “app session establishment request” message from the SASE entity 804, the enterprise application entity 806A or 806B may query about the associated session key by sending the key request message to the GBA/AKMA platform 802.

Upon receiving a valid key request message from the enterprise application entity 806A or 806B, the GBA/AKMA platform 802 may respond by sending a key response message, which carries the session key together with associated parameters. After receiving the key response message from the GBA/AKMA platform 802, the enterprise application entity 806A or 806B may respond to the UE 801 by sending an establishment response message. After transmission of the establishment response message, a secured end-to-end communication channel can be established between the UE 801 and the enterprise application entity 806A or 806B by using the pre-shared session key generated by the GBA/AKMK platform 802. Specifically, a data plane of GBA/AKMA based VPN 809A may be established between the UE 801 and the enterprise application entity 806A, and/or a data plane of GBA/AKMA based VPN 809B may be established between the UE 801 and the enterprise application entity 806B.

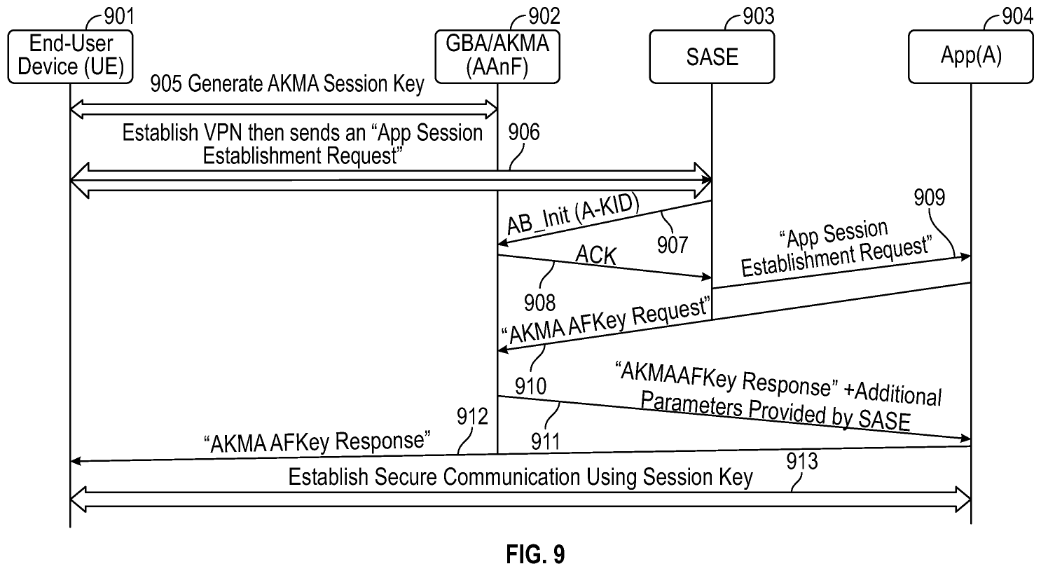

FIG. 9 illustrates an example signal sequence diagram for a process of establishing a secured connection between a UE 901 and an enterprise application entity 904 in an enterprise network according to an embodiment of the present disclosure. Referring to FIG. 9, the UE 901 (also referred to as an end user device) may communicate with the SASE entity 903 on uplink (UL) and downlink (DL) channels. The UE 901 and the SASE entity 903 may be a part of a cellular communication network, such as a 4G or 5G network.

In an operation 905, the UE 901 may initiate communication with GBA/AKMA platform 902. In some embodiments, the GBA/AKMK platform 902 may compute a session key based on the communication with the UE 901. Then the GBA/AKMK platform 902 may share the session key with the SASE entity 903, so that the SASE entity 903 has the confidence about the UE 901's device identity. For example, in some embodiments, the pre-shared key computed via GBA/AKMA platform 902 may be used to secure any communication between the UE 901 and an application authorized by the SASE entity 903. The SASE entity 903 may use key exchange with the UE 901 or the enterprise application entity 904 so as to establish secure communications. In some embodiments of the present disclosure, GBA/AKMA platform 902 may be used to compute and distribute the shared keys. Then a VPN may be established between the UE 901 and the SASE entity 903 using a pre-shared key generated by the GBA/AKMK platform 902.

In an operation 906, the UE 901 may send an establishment request (e.g., “app session establishment request” message as shown in FIG. 9) to a SASE entity 903 after the VPN is established between the UE 901 and the SASE entity 903 using the pre-shared key generated by the GBA/AKMK platform 902. In some embodiments, the establishment request may include a request or attempt to connect with the enterprise application entity (“App (A)”) 904. Then the SASE entity 903 may determine if the UE 901's request or attempt to connect to application A (“app (A)”) may be allowed. If the SASE entity 903 determines to allow the establishment request, the SASE entity 903 may authorize GBA/AKMA platform 902 to share the session key with the application entity. In some embodiments, if the SASE entity 903 determines that the UE 901's request or attempt to connect to application A (“app (A)”) may not be allowed, an error message may be sent to the UE 901. The connection between the UE 901 and the enterprise application entity 904 may thus be terminated.

In some embodiments, if the SASE entity 903 determines that the UE 901's request can be granted, the SASE entity 903 proceeds to communicate with the GBA/AKMA platform 902 in an operation 907. For example, during one such communication, the SASE entity 903 may send an “App_Bootstrap_Initiate” (“AB_Init”) message to the GBA/AKMA (i.e., Bootstrapping Server Function (BSF) of the GBA platform, or AKMA Anchor Function (AAnF) of the AKMA platform) 902 to authorize sharing the session key with App (A) 904. In some embodiments, the message may further comprise some specific properties and/or parameters assigned to the session key based on the UE 901's credentials. The AB_Init message may carry the session key identifier (A-KID) sent by the UE 901 to App (A) 904 in an “app session establishment request” message as illustrated in FIG. 9. In some embodiments, the additional properties/parameters carried in the AB_Init message may include App (A) identifiers, session key lifetime, nonce, etc.

Upon receiving an AB_Init message carrying a valid A-KID from the SASE entity 903, the GBA/AKMA platform 902 may store the additional properties and/or parameters sent in the AB_Init message. Then in an operation 908, the GBA/AKMK platform 902 may send an acknowledge (ACK) response to the SASE entity 903. In some embodiments, if it is in a 4G network scenario and GBA platform is used, the AKMA Anchor Function (AAnF) included in the GBA platform may store the additional properties and/or parameters in the AB_Init message, and send the ACK message to the SASE 903. On the other hand, in case of a 5G network scenario, the AKMA platform may be used instead of the GBA platform, then Bootstrapping Server Function (BSF) may be used to store the additional properties and/or parameters in the AB_Init message and send the ACK message to the SASE entity 903.

After receiving the acknowledge (ACK) response from the GBA/AKMA platform 902, in an operation 909, the SASE entity 903 may forward the “app session establishment request” message to App (A) 904. Upon receiving an “app session establishment request” message from the SASE entity 903, the App (A) 904 may query about the associated session key by sending the “AKMA AFKey Request” message to the AAnF (or by sending a similar request to the BSF for GBA) in an operation of 910.

Upon receiving a valid “AKMA AFKey Request” message from App (A) 904, the AAnF of a AKMA platform may respond by sending an “AKMA AFKey Response” message, which carries the session key together with associated parameters in an operation of 911. In some embodiments, when GBA is used instead of AKMA, the AAnF node may be replaced by the BSF, which would receive a request similar to the “AKMA AFKey Request” and send a response similar to the “AKMA AFKey Response”.

After receiving an “AKMA AFKey Response” message from the AAnF (or receiving a similar response from the BSF for GBA), the App (A) 904 may respond to the UE 901 by sending an “AKMA AFKey Response” (or similar response if the GBA platform is used) in an operation 912. After the transmission of the “AKMA AFKey Response” (or transmission of similar response if the GBA platform is used), in an operation 913, secure end-to-end communication may be established between the UE 901 and App (A) 904 by using the pre-shared session key computed by the GBA/AKMA platform 902.

Embodiments of the present disclosure leverage 4G/5G embedded security to offer both VPN capabilities and granular control over end-to-end encryption between a user equipment (UE) and corporate IT services (e.g., applications in the enterprise networks) based on Zero Trust Network Access (ZTNA), which may provide access only to an explicitly authorized end user device inside or outside of an enterprise network.

In addition to enabling embedded VPN, the embodiments of the present disclosure integrate SASE features (crypto-tables, artificial intelligence (AI), firewall, proxy, etc.) in the enhanced UPF and allow pushing such node closer to the IT services running on premise and/or in public cloud. In addition, VPN encryption granularity can be coordinated by the SASE on a per application, per user device, and/or per user basis. Devices and applications do not need any additional key, as is the case of traditional VPN certificate. They just need the 4G/5G (or any future cellular generations) keys, such as eSIM profile keys. Any communication from or to the devices that support the embodiments of the present disclosure go through a SASE firewall (FW). Embodiments of the present disclosure allow provisioning SASE entity 903 to decide whether it needs to snoop at packets whenever needed, taking into consideration initiator identity, status, time, location, type of application, etc., between the end user device (e.g., UE) and the targeted app(s) or allows a full end-to-end secure communication between the two entities.

Strong security requires end-to-end security (i.e., encryption). In fact, each time a middlebox, such as the SASE entity 903, terminates the encrypted VPN tunnel and re-initiates it, a weakness/vulnerability is introduced, because data packets will be unencrypted before they get encrypted again. On the other side, establishing end-to-end encryption is conditioned by enabling the two endpoints to trust each other. Embodiments of the present disclosure establish such trust by using the GBA/AKMA platform (e.g., platform 902). Furthermore, in some embodiments of the present disclosure, end-to-end (e2e) encryption can be the default configuration. As a result, it limits the role of the anchor node (e.g., the SASE entity) to address exceptional cases where restrictions are required in order to implement closer real time monitoring.

For example, “internal” corporate hackers are not uncommon anymore and may even be a significant threat nowadays. Therefore, while applications in enterprise networks can use a GBA/AKMA platform (e.g., platform 902), the capability of gathering additional data related to the identity of who is trying to connect to the applications can sometimes be beneficial to make a decision. For example, if a contractor/intern is trying to connect to a “sensitive” application late at night or during a weekend or his location cannot be trusted, etc., the SASE entity may not allow the default end-to-end encryption between the two entities. On the other side, such restriction will not be necessary if an executive, for example, is trying to connect to an application.

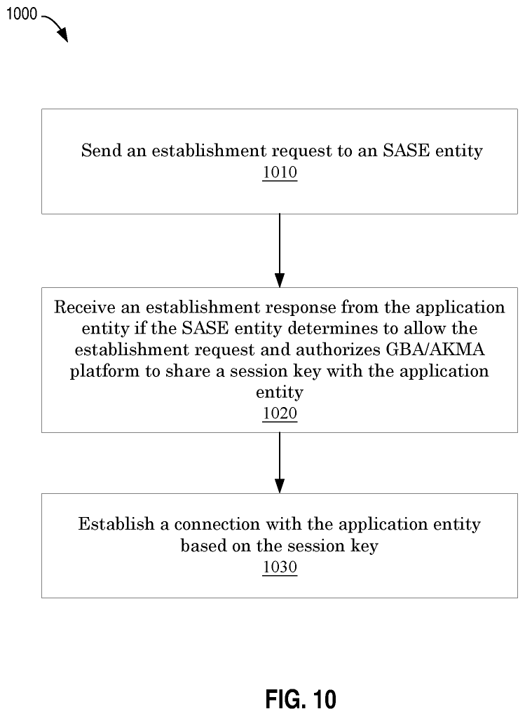

FIG. 10 shows an example flowchart illustrating an example method 1000 performed by a UE (e.g., UE 901 or any other UEs described above) for establishing a secured connection with an application entity (e.g., enterprise application entity 904 or any other application entities described above) in an enterprise network in accordance with some embodiments of the present disclosure. In step 1010, the UE may be configured to send an establishment request (e.g., an “app session establishment request” message as described above) to a secure access secure edge (SASE) entity (e.g., entity 903). Then the SASE entity may determine whether to allow the establishment request and authorize a GBA/AKMA platform (e.g., platform 902 or any other GBA/AKMA platform described above) to share a session key with the application entity.

If the SASE entity determines to allow the establishment request and authorize the GBA/AKMA platform to share a session key with the application entity, the method 1000 proceeds to step 1020. In step 1020, the UE may be configured to receive an establishment response (e.g., an “AKMA AFKey Response” message or a similar response from the BSF for GBA as described above) from the application entity if the SASE entity determines to allow the establishment request and authorizes GBA/AKMA platform to share a session key with the application entity. On the other hand, in some embodiments, if the SASE entity determines not to allow the establishment request, then the UE may be configured to receive an error message from the SASE entity and terminate a connection between the user equipment 901 and the application entity.

In some embodiments, the UE may be configured to generate a session key with the GBA/AKMA platform before it sends the establishment request to the SASE entity in step 1010. In some embodiments, the UE may be configured to generate a session key with the GBA/AKMA platform and establish a virtual private network (VPN) tunnel with the SASE entity before the UE sends the establishment request to the SASE entity in step 1010. In some embodiments, the session key may be computed by the GBA/AKMA platform.

After the UE receives the establishment response from the application entity 904, method 1000 proceeds to step 1030, in which the UE may be configured to establish a connection with the application entity based on the session key computed by the GBA/AKMA platform.

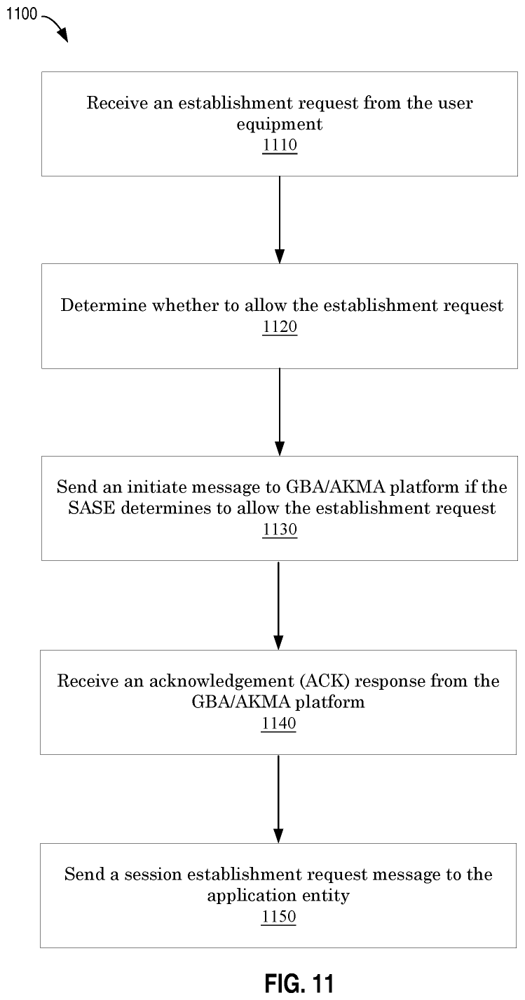

FIG. 11 shows an example flowchart illustrating an example method 1100 performed by a SASE entity (e.g., entity 903 or any other SASE entities described above) for establishing a secured connection between a UE (e.g., UE 901 or any other UEs described above) and an application entity (e.g., enterprise application entity 904 or any other application entities described above) in an enterprise network in accordance with some embodiments of the present disclosure. In step 1110, the SASE entity may be configured to receive an establishment request (e.g., an “app session establishment request” message as described above) from the UE. In some embodiments, the establishment request may comprise a session key identifier. Then in step 1120, the SASE entity may be configured to determine whether to allow the establishment request. If the SASE entity determines to allow the establishment request, method 1100 proceeds to step 1130.

In step 1130, the SASE entity may be configured to send an initiate message (e.g., an “App_Bootstrap_Initiate” message or “AB_Init” message as described above) to a GBA/AKMA platform (e.g., platform 902 or any other GBA/AKMA platforms) if the SASE entity determines to allow the establishment request. In some embodiments, the initiate message may comprise an authorization to share a session key with the application entity. The initiate message may carry the session key identifier (e.g., an A-KID as described above) sent by the UE to the application entity in the establishment request.

On the other hand, in some embodiments, if in step 1120 the SASE entity determines not to allow the establishment request, the SASE entity may be configured to send an error message to the UE to terminate a connection between the UE and the application entity. In some embodiments, the initiate message may further comprise at least one of the following: one or more properties assigned to the session key based on credentials of the user equipment: or session key identifier. In some embodiments, the GBA/AKMA platform stores at least one of the following parameters after it receives the initiate message from the SASE entity: application identifiers: or session key lifetime.

In step 1140, the SASE entity may be configured to receive an acknowledgement (ACK) response from the GBA/AKMA platform. In step 1150, the SASE entity may be configured to send a session establishment request message to the application entity. For example, the SASE entity may forward the “app session establishment request” message to the application entity.

The foregoing specification is to be understood as being in every respect illustrative and exemplary, but not restrictive, and the scope of the present disclosure disclosed herein is not to be determined from the specification, but rather from the claims as interpreted according to the full breadth permitted by the patent laws. It is to be understood that the embodiments shown and described herein are only illustrative of the principles of the present disclosure and that various modifications may be implemented by those skilled in the art without departing from the scope and spirit of the present disclosure. Those skilled in the art could implement various other feature combinations without departing from the scope and spirit of the present disclosure.

ABBREVATIONS

| | |
|---|---|
| SASE | Secure Access Secure Edge |
| GBA | Generic Bootstrapping Architecture |
| AKMA | Authentication and Key Management for Applications |
| VPN | Virtual Private Network |
| AAnF | AKMA Anchor Function |
| BSF | Bootstrapping Server Function |
| GW | Gateway |
| SD-WAN | Software Defined Wide Area Network |
| NAF | Network Access Function |
| HSS | Home Subscriber Service |
| GUSS | GBA User Settings |
| AKA | Authentication and Key Agreement |
| TLS | Transport Layer Security |
| AF | Application Function |
| AUSF | Authentication Server Function |
| A-KID | AKMA Key Identifier |
| 1x RTT | CDMA2000 1x Radio Transmission Technology |
| 3GPP | 3rd Generation Partnership Project |
| 5G | 5th Generation |
| DL | Downlink |
| DM | Demodulation |
| DMRS | Demodulation Reference Signal |
| DRX | Discontinuous Reception |
| DTX | Discontinuous Transmission |
| DTCH | Dedicated Traffic Channel |
| DUT | Device Under Test |
| E-CID | Enhanced Cell-ID (positioning method) |
| eMBMS | evolved Multimedia Broadcast Multicast Services |
| E-SMLC | Evolved-Serving Mobile Location Centre |
| ECGI | Evolved CGI |
| eNB | E-UTRAN NodeB |
| ePDCCH | Enhanced Physical Downlink Control Channel |
| E-SMLC | Evolved Serving Mobile Location Center |
| E-UTRA | Evolved UTRA |
| E-UTRAN | Evolved UTRAN |
| FDD | Frequency Division Duplex |
| FFS | For Further Study |
| gNB | Base station in NR |
| GNSS | Global Navigation Satellite System |
| HARQ | Hybrid Automatic Repeat Request |
| HO | Handover |
| HSPA | High Speed Packet Access |
| HRPD | High Rate Packet Data |
| LOS | Line of Sight |
| LPP | LTE Positioning Protocol |
| LTE | Long-Term Evolution |
| MAC | Medium Access Control |
| MBSFN | Multimedia Broadcast multicast service Single Frequency |
| | Network |
| MBSFN ABS | MBSFN Almost Blank Subframe |
| MDT | Minimization of Drive Tests |
| MIB | Master Information Block |
| MME | Mobility Management Entity |
| MSC | Mobile Switching Center |
| NPDCCH | Narrowband Physical Downlink Control Channel |
| NR | New Radio |
| OCNG | OFDMA Channel Noise Generator |
| OFDM | Orthogonal Frequency Division Multiplexing |
| OFDMA | Orthogonal Frequency Division Multiple Access |
| OSS | Operations Support System |
| OTDOA | Observed Time Difference of Arrival |
| O&M | Operation and Maintenance |
| PBCH | Physical Broadcast Channel |
| P-CCPCH | Primary Common Control Physical Channel |
| PCell | Primary Cell |
| PCFICH | Physical Control Format Indicator Channel |
| PDCCH | Physical Downlink Control Channel |
| PDCP | Packet Data Convergence Protocol |
| PDP | Profile Delay Profile |
| PDSCH | Physical Downlink Shared Channel |
| PGW | Packet Gateway |
| PHICH | Physical Hybrid-ARQ Indicator Channel |
| PLMN | Public Land Mobile Network |
| PMI | Precoder Matrix Indicator |
| PRACH | Physical Random Access Channel |
| PRS | Positioning Reference Signal |
| PSS | Primary Synchronization Signal |
| PUCCH | Physical Uplink Control Channel |
| PUSCH | Physical Uplink Shared Channel |
| RACH | Random Access Channel |
| QAM | Quadrature Amplitude Modulation |
| RAN | Radio Access Network |
| RAT | Radio Access Technology |
| RLC | Radio Link Control |
| RLM | Radio Link Management |
| RNC | Radio Network Controller |
| RNTI | Radio Network Temporary Identifier |
| RRC | Radio Resource Control |
| RRM | Radio Resource Management |
| RS | Reference Signal |
| RSCP | Received Signal Code Power |
| RSRP | Reference Symbol Received Power OR |
| | Reference Signal Received Power |
| RSRQ | Reference Signal Received Quality OR |
| | Reference Symbol Received Quality |
| RSSI | Received Signal Strength Indicator |
| RSTD | Reference Signal Time Difference |
| SCH | Synchronization Channel |
| SCell | Secondary Cell |
| SDAP | Service Data Adaptation Protocol |
| SDU | Service Data Unit |
| SFN | System Frame Number |
| SGW | Serving Gateway |
| SI | System Information |
| SIB | System Information Block |
| SNR | Signal to Noise Ratio |
| SON | Self Optimized Network |
| SS | Synchronization Signal |
| SSS | Secondary Synchronization Signal |
| TDD | Time Division Duplex |
| TDOA | Time Difference of Arrival |
| TOA | Time of Arrival |
| TSS | Tertiary Synchronization Signal |
| TTI | Transmission Time Interval |
| UE | User Equipment |
| UL | Uplink |
| USIM | Universal Subscriber Identity Module |
| UTDOA | Uplink Time Difference of Arrival |
| WCDMA | Wide CDMA |
| WLAN | Wide Local Area Network |

1. A method performed by a user equipment (UE) for establishing a secured connection with an application entity in an enterprise network, the method comprising:
sending an establishment request to a Secure Access Secure Edge (SASE) entity;
receiving an establishment response from the application entity if the SASE entity determines to allow the establishment request and authorizes a Generic Bootstrapping Architecture/Authenticated Key Management for Application (GBA/AKMA) platform to share a session key with the application entity; and
establishing a connection with the application entity based on the session key.

2. The method of claim 1, further comprising the steps of:
receiving an error message from the SASE entity if the SASE entity determines not to allow the establishment request; and
terminating a connection between the UE and the application entity.

3. The method of claim 1, further comprising the step of:
generating a session key with the GBA/AKMA platform before sending the establishment request to the SASE entity.

4. The method of claim 1, further comprising the step of:
establishing a Virtual Private Network virtual private network (VPN) tunnel with the SASE entity before sending the establishment request to the SASE entity.

5. The method of claim 1, wherein the session key is computed by the GBA/AKMA platform.

6. The method of claim 1, further comprising:
providing user data; and
forwarding the user data to a host via the transmission to the application entity.

7. A method performed by a Secure Access Secure Edge (SASE) entity for establishing a secured connection between a user equipment (UE) and an application entity in an enterprise network, the method comprising:
receiving an establishment request from the UE;
determining whether to allow the establishment request;
sending an initiate message to a Generic Bootstrapping Architecture/Authenticated Key Management for Application (GBA/AKMA) platform if the SASE entity determines to allow the establishment request;
receiving an acknowledgement (ACK) response from the GBA/AKMA platform; and
sending a session establishment request message to the application entity, wherein the initiate message comprises an authorization to share a session key with the application entity.

8. The method of claim 7, further comprising the step of:
sending an error message to the UE to terminate a connection between the UE and the application entity if the SASE entity determines not to allow the establishment request.

9. The method of claim 7, wherein the establishment request comprises a session key identifier.

10. The method of claim 7, wherein the initiate message comprises at least one of the following:
one or more properties assigned to the session key based on credentials of the UE, or
the session key identifier.

11. A method performed by a computer-implemented controller for establishing a secured connection between a user equipment (UE) and an application entity in an enterprise network, the method comprising:
receiving an establishment request from the UE;
determining whether to allow the establishment request;
sending an initiate message to a Generic Bootstrapping Architecture/Authenticated Key Management for Application (GBA/AKMA) platform if the computer-implemented controller determines to allow the establishment request;
receiving an acknowledgement (ACK) response from the GBA/AKMA platform; and
sending a session establishment request message to the application entity, wherein the initiate message comprises an authorization to share a session key with the application entity.

12. The method of claim 11, further comprising the step of:
sending an error message to the UE to terminate a connection between the UE and the application entity if the computer-implemented controller determines not to allow the establishment request.

13. The method of claim 11, wherein the establishment request comprises a session key identifier.

14. The method of claim 11, wherein the initiate message comprises at least one of the following:
one or more properties assigned to the session key based on credentials of the user equipment, or
the session key identifier.

15. A user equipment (UE) for establishing a secured connection with an application entity in an enterprise network, comprising:
processing circuitry configured to perform:
sending an establishment request to a Secure Access Secure Edge (SASE) entity;
receiving an establishment response from the application entity if the SASE entity determines to allow the establishment request and authorizes a Generic Bootstrapping Architecture/Authenticated Key Management for Application (GBA/AKMA) platform to share a session key with the application entity; and
establishing a connection with the application entity based on the session key; and
power supply circuitry configured to supply power to the processing circuitry.

16. A computer-implemented controller for establishing a secured connection between a user equipment (UE) and an application entity in an enterprise network, the computer-implemented controller comprising:
processing circuitry configured to perform:
receiving an establishment request from the UE;
determining whether to allow the establishment request;
sending an initiate message to a Generic Bootstrapping Architecture/Authenticated Key Management for Application (GBA/AKMA) platform if the processing circuitry determines to allow the establishment request;
receiving an acknowledgement (ACK) response from the GBA/AKMA platform; and
sending a session establishment request message to the application entity, wherein the initiate message comprises an authorization to share a session key with the application entity; and
power supply circuitry configured to supply power to the processing circuitry.
